(19) United States
(12) Patent Application Publication
(10) Pub. No.: US 2023/0377537 A1
(43) Pub. Date: Nov. 23, 2023

(54) DISPLAY DEVICE, DISPLAY METHOD, AND PROGRAM

(71) Applicant: NIPPON TELEGRAPH AND TELEPHONE CORPORATION, Tokyo (JP)

(72) Inventors: Yusuke YOSHIMURA, Musashino-shi, Tokyo (JP); Kenji HIYOSHI, Musashino-shi, Tokyo (JP)

(73) Assignee: NIPPON TELEGRAPH AND TELEPHONE CORPORATION, Tokyo (JP)

(21) Appl. No.: 18/031,161

(22) PCT Filed: Oct. 27, 2020
(86) PCT No.: PCT/JP2020/040199

§ 371 Date: Apr. 11, 2023

(51) Int. Cl. G09G 5/377; G06T 5/50; G06T 7/70

(52) U.S. Cl. CPC G09G 5/377; G06T 5/50; G06T 7/70; G06T 2207/20221

(57) ABSTRACT

A display device (3) according to the present disclosure includes: an imaging unit (31) that images a subject and generates a captured image; an imaging position calculation unit (35) that calculates an imaging absolute position that is an absolute position of the imaging unit (31); an equipment information acquisition unit (36) that acquires an equipment absolute position that is an absolute position of equipment on the basis of the imaging absolute position; a relative position calculation unit (37) that calculates a relative position of the equipment with respect to the imaging unit on the basis of the imaging absolute position and the equipment absolute position; an image superimposition unit (38) that generates a superimposed image in which the object corresponding to the equipment is superimposed on the captured image on the basis of the relative position; and a display unit (39) that displays the superimposed image.

### TECHNICAL FIELD

The present disclosure relates to a display device, a display method, and a program for displaying a superimposed image in which an object is superimposed on a captured image.

### BACKGROUND ART

Orderers and contractors of road construction must ensure safe execution of road construction and prevent accidents. Therefore, an orderer and a contractor need to ask for the presence of an equipment manager who is from an electric power company, a gas supply company, a communication company, or the like and who manages equipment laid in a range to be a target of the road construction when performing the road construction (Non Patent Literature 1).

In a case where equipment of the company is laid in a range of road construction, an equipment manager needs to carry out enforcement at a site of the road construction, check drawings at the site of the road construction such that accidents are not caused, and transmit a position of the equipment to an orderer and a contractor (Non Patent Literature 2). At this time, the equipment manager checks the drawings indicating the position of the equipment created at the time of laying the equipment, and displays a mark indicating the position corresponding to the equipment on the ground surface or the like of the site of the road construction with ink or the like.

### CITATION LIST

### Non Patent Literature

Non Patent Literature 1: “Explanation of construction work public disaster prevention measures guidelines,” Technical Research Division and Land and Construction Industry Bureau Construction Industry Division of the Ministry of Land, Infrastructure, Transport and Tourism, Minister's Secretariat, September 2019
Non Patent Literature 2: “Guidelines for accident prevention measures for underground buried objects (draft),” Tohoku Regional Development Bureau of the Ministry of Land, Infrastructure, Transport and Tourism, October 2016

### SUMMARY OF INVENTION

### Technical Problem

However, each equipment manager may need to visit and carry out enforcement at as many sites as that of the number of road constructions in the entire country, which incurs high costs.

Therefore, there is a demand for a technique for reducing the cost for an equipment manager to visit and carry out enforcement at a site of road construction, and for an orderer and a contractor to ascertain the position of equipment and ensure safe construction.

An object of the present disclosure made in view of the above problems is to provide a display device, a display method, and a program that enable an orderer and a contractor to ascertain a position of equipment and ensure safe construction without an equipment manager visiting and carrying out enforcement at a site of road construction.

### Solution to Problem

In order to solve the above problems, a display device according to the present disclosure includes: an imaging unit that images a subject and generates a captured image; an imaging position calculation unit that calculates an imaging absolute position that is an absolute position of the imaging unit; an equipment information acquisition unit that acquires an equipment absolute position that is an absolute position of equipment on the basis of the imaging absolute position; a relative position calculation unit that calculates a relative position of the equipment with respect to the imaging unit on the basis of the imaging absolute position and the equipment absolute position; an image superimposition unit that generates a superimposed image in which the object corresponding to the equipment is superimposed on the captured image on the basis of the relative position; and a display unit that displays the superimposed image.

Furthermore, in order to solve the above problems, a display method according to the present disclosure is a display method of a display device including an imaging unit, the display method including: a step of imaging a subject and generating a captured image; a step of calculating an imaging absolute position that is an absolute position of the imaging unit; a step of acquiring an equipment absolute position that is an absolute position of equipment on the basis of the imaging absolute position on the basis of the imaging absolute position; a step of calculating a relative position of the equipment with respect to the imaging unit, on the basis of the imaging absolute position and the equipment absolute position; a step of generating a superimposed image in which the object corresponding to the equipment is superimposed on the captured image, on the basis of the relative position; and a step of displaying the superimposed image.

In order to solve the above problems, a program according to the present disclosure causes a computer to function as the above-described display device.

### Advantageous Effects of Invention

With the display device, the display method, and the program according to the present disclosure, an orderer and a contractor can ascertain a position of equipment and secure safe construction without an equipment manager visiting a site of road construction.

### BRIEF DESCRIPTION OF DRAWINGS

FIG. 1 is a schematic diagram of a display system according to a first embodiment of the present disclosure.

FIG. 2 is a diagram for describing a positional relationship among a mobile station, an imaging unit, and equipment illustrated in FIG. 1.

FIG. 3 is a diagram for describing the position of the imaging unit in each of a reference posture and a current posture in a polar coordinate system with the position of the mobile station illustrated in FIG. 2 as an origin.

FIG. 4 is a diagram illustrating an example of a superimposed image displayed by a display device illustrated in FIG. 1.

FIG. 5 is a flowchart illustrating an example of the operation of the display device illustrated in FIG. 1.

FIG. 6 is a schematic diagram of a display system according to a second embodiment of the present disclosure.

FIG. 7 is a diagram illustrating an example of a superimposed image displayed by a display device illustrated in FIG. 6.

FIG. 8 is a diagram illustrating another example of a superimposed image displayed by the display device illustrated in FIG. 6.

FIG. 9 is a flowchart illustrating an example of the operation of the display device illustrated in FIG. 6.

### DESCRIPTION OF EMBODIMENTS

Hereinafter, a first embodiment of the present disclosure will be described with reference to the drawings.

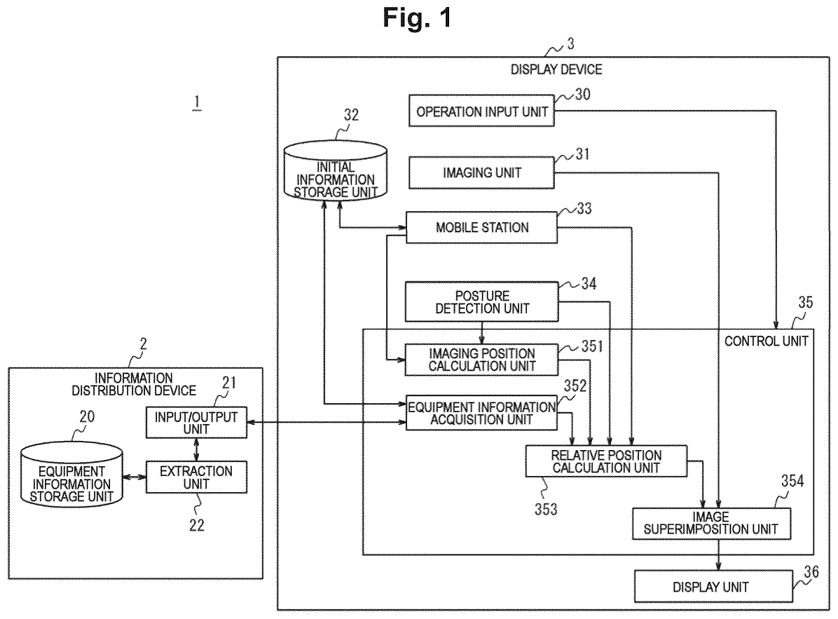

First, an overall configuration of the first embodiment will be described with reference to FIG. 1.

FIG. 1 is a schematic diagram of a display system 1 according to the first embodiment of the present invention.

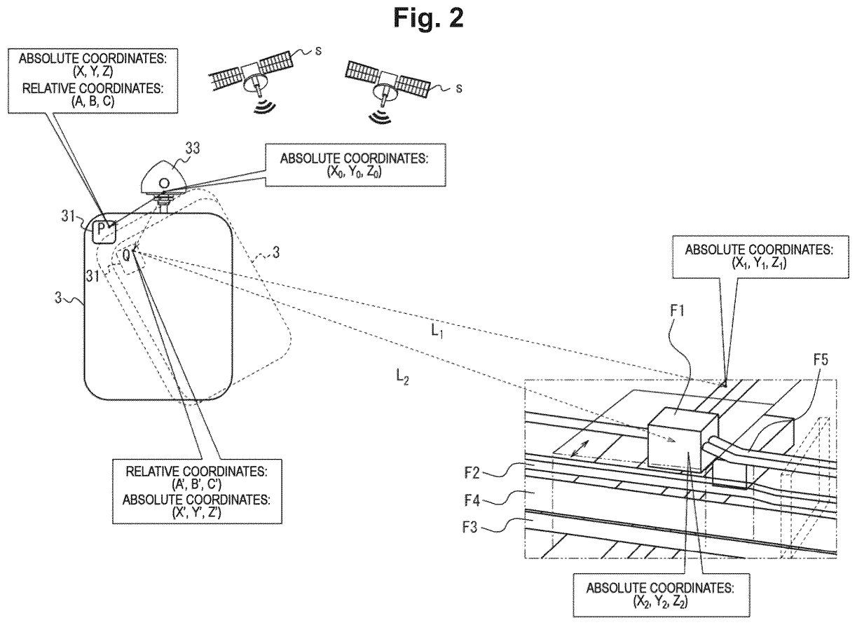

As illustrated in FIG. 1, the display system 1 according to the first embodiment includes an information distribution device 2 and a display device 3. The display device 3 is connected to the information distribution device 2 via a communication network, and these transmit and receive information to and from each other. In addition, as illustrated in FIG. 2, the display device 3 receives a signal from a positioning satellite S of a global navigation satellite system (GNSS). The GNSS can be, for example, a satellite positioning system such as a global positioning system (GPS), GLONASS, Galileo, or a quasi-zenith satellite (QZSS).

The information distribution device 2 is configured as a computer including a processor, a memory, and an input/output interface. The computer constituting the information distribution device 2 can be any computer such as a server computer, a supercomputer, or a mainframe. The information distribution device 2 includes an equipment information storage unit 20, an input/output unit 21, and an extraction unit 22.

The equipment information storage unit 20 is a hard disk drive (HDD), a solid state drive (SSD), an electrically erasable programmable read-only memory (EEPROM), a read-only memory (ROM), a random access memory (RAM), a universal serial bus (USB), or the like, and includes a memory. The equipment information storage unit 20 may function as, for example, a main storage device, an auxiliary storage device, or a cache memory. The equipment information storage unit 20 stores arbitrary information used for the operation of the information distribution device 2. For example, the equipment information storage unit 20 may store a system program, an application program, various types of information input by the input/output unit 21, and the like. The equipment information storage unit 20 may be built into the housing of the information distribution device 2, or and may be an external database or an external storage module connected by a digital input/output port such as a USB or the like.

The equipment information storage unit 20 stores equipment information which is information on equipment F.

The equipment may be an object laid at the site of construction and may be a buried object buried under the ground, or may be an object disposed on the ground. As illustrated in FIG. 2, the equipment F includes point equipment and line equipment. The point equipment is equipment for which a form of laying thereof can be recognized by indicating with one point on a map, and includes, for example, a manhole F1, a handhole, and a gas valve. The line equipment is equipment for which a form of laying thereof can be recognized by indicating with a line or a plurality of points on a map, and includes, for example, pipes such as a power pipe F2, and a gas pipe F3, and a water pipe F4, and a water passage such as a culvert F5.

The equipment information includes equipment position information and an object J1. The equipment position information indicates an equipment absolute position where the equipment is laid, and is indicated by absolute coordinates (Xₖ, Yₖ, Zₖ) in a three-dimensional orthogonal coordinate system corresponding to latitude, longitude, and height (k is an integer of 1 to n) in the example illustrated in FIG. 2. The equipment position information is information indicating a more exact position than in a conventional plant record. The position of the point equipment is indicated by at least one piece of position information, and includes, for example, the position of the center of gravity of the point equipment.

The position of the line equipment is indicated by a plurality of pieces of position information. In the line equipment, for example, equipment position information of a pipe extending on a straight line includes positions of both ends of the pipe. In the line equipment, for example, equipment position information of a pipe extending in a bent manner includes positions of both ends of the pipe, inflection points, and the like. The object J1 includes a 3D object indicating equipment, which can be superimposed on an image. For example, the object J1 may be a 3D object imitating an appearance of equipment.

The input/output unit 21 includes an input/output interface. The input/output unit 21 receives input of imaged position information indicating an absolute position of an imaging unit 31, which will be described in detail later, output from the display device 3. In addition, the input/output unit 21 outputs the equipment information extracted by the extraction unit 22 to the display device 3.

The extraction unit 22 includes a processor. The “processor” can be a general-purpose processor or a dedicated processor specialized for a specific process, and is not limited thereto. The processor may be, for example, a central processing unit (CPU), a graphics processing unit (GPU), a digital signal processor (DSP), an application specific integrated circuit (ASIC), or the like.

The extraction unit 22 extracts the equipment information stored in the equipment information storage unit 20 on the basis of the imaged position information input by the input/output unit 21. Specifically, the extraction unit 22 extracts the equipment information stored in correspondence with the absolute position or the peripheral position of the absolute position of the imaging unit 31. The peripheral position is a position included in a range that can be a target of imaging by the imaging unit 31, and can be, for example, a position included in a range within 100 meters from the position of the imaging unit 31. The extraction unit 22 extracts n (n is an integer) pieces of equipment information stored in the equipment information storage unit 20 in correspondence with the absolute position or the peripheral position.

The display device 3 is configured as a computer including a processor, a memory, a display, a camera, an input/output interface, and a sensor. The computer constituting the display device 3 can be, for example, a portable information terminal such as a tablet computer, a laptop computer, or a smartphone.

The display device 3 includes an operation input unit 30, an imaging unit 31, an initial information storage unit 32, a mobile station 33, a posture detection unit 34, a control unit 35, and a display unit 36. The control unit 35 includes an imaging position calculation unit 351, an equipment information acquisition unit 352, a relative position calculation unit 353, and an image superimposition unit 354.

The operation input unit 30 includes an input interface that receives a command to the display device 3 by a user's operation. The operation input unit 30 receives a start command for starting display processing by the display device 3 and an end command for ending the display processing by the display device 3. The operation input unit 30 outputs the received start command and end command to the control unit 35. Note that the start command and the end command may correspond to start and end of a display application for the display device 3 to perform display processing, respectively.

The imaging unit 31 includes a camera. The imaging unit 31 images a subject and generates a captured image. Furthermore, the imaging unit 31 may image the subject at predetermined time intervals to generate a video including a plurality of captured images. The imaging unit 31 outputs the generated captured image and video to the image superimposition unit 354.

The initial information storage unit 32 includes a memory. The initial information storage unit 32 stores initial information in advance. The initial information includes connection destination information for connection to the positioning satellite S of the GNSS via the communication network and connection destination information for connection to the information distribution device 2 via the communication network. The initial information storage unit 32 may store initial information input by the operation input unit 30, or may store initial information received from another device via the communication network. In addition, the initial information storage unit 32 can update the already stored initial information with the initial information newly input or received at an arbitrary timing.

The mobile station 33 is a mobile station of GNSS. The mobile station 33 receives a signal from the positioning satellite S, which is a reference station of the GNSS, and calculates the mobile station absolute position and the mobile station direction on the basis of the signal. The mobile station absolute position is an absolute position of the mobile station 33, and is indicated by absolute coordinates (X₀, Y₀, Z₀) in a three-dimensional orthogonal coordinate system corresponding to latitude, longitude, and height in the example illustrated in FIG. 2. The mobile station direction is a direction in which the antennas constituting the mobile station 33 face, and is indicated by orientations of east, west, north, and south.

Specifically, the mobile station 33 requests a signal from the positioning satellite S by using the connection destination information to the positioning satellite S stored in the initial information storage unit 32. The mobile station 33 receives a signal transmitted from the positioning satellite S, and calculates the mobile station absolute position and the mobile station direction on the basis of the signal. The mobile station 33 outputs information indicating the calculated mobile station absolute position and mobile station direction to the relative position calculation unit 353.

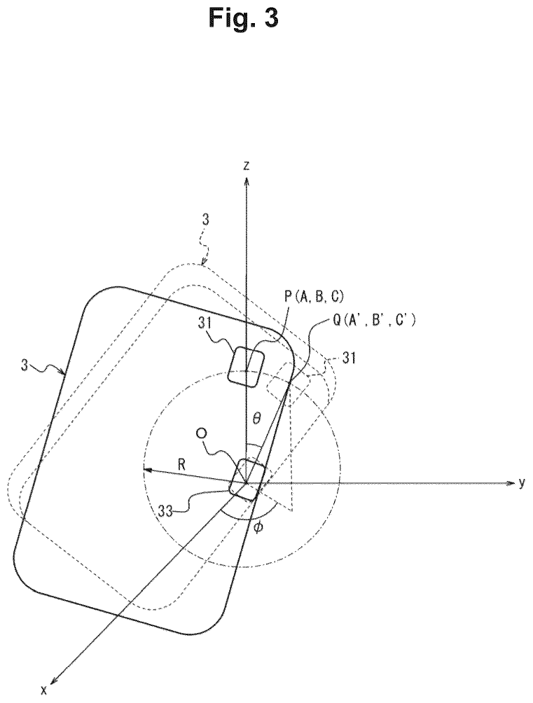

The posture detection unit 34 includes a motion sensor including an acceleration sensor and a geomagnetic sensor. The posture detection unit 34 detects the posture of display device 3. In FIGS. 2 and 3, the display device 3 indicated by a solid line is in the state of the reference posture, and the display device 3 indicated by a broken line is in the state of the detection posture that is the posture detected by the posture detection unit 34. Specifically, the posture detection unit 34 detects the inclination of the display device 3 in the change from the state in which the display device 3 is in the reference posture to the state in which the display device 3 is in the detection posture as the posture of the display device 3. The posture detection unit 34 outputs the calculated posture to the imaging position calculation unit 351. As illustrated in FIG. 3, the inclination is represented by, for example, a roll angle θ and a pitch angle φ. In FIG. 2, the mobile station 33 is attached to the outside of the housing of the display device 3, and in FIG. 3, the mobile station 33 is built into the housing of the display device 3.

The control unit 35 includes a processor. The control unit 35 determines whether or not the operation input unit 30 has received a start command, and starts the operation when determining that the start command has been received. The control unit 35 determines whether or not the operation input unit 30 has received an end command, and ends the operation when determining that the end command has been received.

The imaging position calculation unit 351 calculates an imaging absolute position that is an absolute position of the imaging unit 31. Here, a method by which the imaging position calculation unit 351 calculates the imaging absolute position will be described in detail. In the example of FIG. 2, the imaging absolute position in a state where the display device 3 is in the reference posture is indicated by absolute coordinates (X, Y, Z) in the three-dimensional orthogonal coordinate system. Furthermore, the imaging absolute position in a state where the display device 3 is in the detection posture is indicated by absolute coordinates (X′, Y′, Z′) in a three-dimensional orthogonal coordinate system.

First, the imaging position calculation unit 351 calculates a detection relative position Q on the basis of the posture (detection posture) of the display device 3 detected by the posture detection unit 34 and a reference relative position P. The reference relative position P is a relative position of the imaging unit 31 with respect to a position O of the mobile station 33 in a state where the display device 3 is in the reference posture, and is known. The detection relative position Q is a relative position of the imaging unit 31 with respect to the position O of the mobile station 33 in a state where the display device 3 is in the detection posture. In the examples illustrated in FIGS. 2 and 3, the reference relative position P is indicated by relative coordinates (A, B, C) in a three-dimensional orthogonal coordinate system with the position O of the mobile station 33 as an origin, and the detection relative position Q is indicated by relative coordinates (A′, B′, C′) in the three-dimensional orthogonal coordinate system.

The positional relationship between the camera constituting the imaging unit 31 and the mobile station 33 is fixed. For example, the positional relationship may be fixed by fixing the camera constituting the imaging unit 31 and the mobile station 33 to the housing constituting the display device 3. Therefore, as illustrated in FIG. 3, even if the state of the display device 3 changes from the reference posture to the detection posture, a distance R between the imaging unit 31 and the mobile station 33 is constant. In addition, when the state of the display device 3 changes from the reference posture to the detection posture, the direction of the imaging unit 31 with respect to the mobile station 33 changes by the roll angle θ and the pitch angle φ detected by the posture detection unit 34. Therefore, the imaging position calculation unit 351 calculates the detection relative position Q indicated by the relative coordinates (A′, B′, C′) that satisfy Equations (1) to (4).

[Math. 1]

R=\sqrt{A²+B²+C²} (1)

A′=R sin θ cos φ (2)

B′=R sin θ sin φ (3)

C′=R cos θ (4)

Next, the imaging position calculation unit 351 calculates the imaging absolute position on the basis of the absolute position of the mobile station 33 indicated by the mobile station information and the detection relative position Q of the imaging unit 31 with respect to the mobile station 33. In the example illustrated in FIG. 2, the imaging position calculation unit 351 calculates the imaging absolute position indicated by the imaging absolute coordinates (X′, Y′, Z′) on the basis of the absolute coordinates (X₀, Y₀, Z₀) of the absolute position of the mobile station 33 and the relative coordinates (A′, B′, C′) indicating the relative position of the imaging unit 31. The imaging position calculation unit 351 outputs the calculated imaging absolute position to the relative position calculation unit 353.

As illustrated in FIG. 1, the equipment information acquisition unit 352 can acquire the equipment information including the equipment absolute position, which is the absolute position of the equipment, via the input/output interface or the communication interface. For example, the equipment information acquisition unit 352 determines whether or not the equipment information is stored in the memory of the display device 3. When it is determined that the equipment information is stored in the memory of the display device 3, the equipment information acquisition unit 352 does not perform processing for acquiring the equipment information. When it is determined that the equipment information is not stored in the memory of the display device 3, the equipment information acquisition unit 352 acquires the equipment information. The equipment information acquisition unit 352 stores the equipment information output from the information distribution device 2 in the memory of the display device 3.

Specifically, the equipment information acquisition unit 352 outputs imaged position information indicating the imaging absolute position calculated by the imaging position calculation unit 351 and an equipment information acquisition request to the information distribution device 2. At this time, the equipment information acquisition unit 352 can output the imaged position information and the equipment information acquisition request to the information distribution device 2 by using the connection information to the information distribution device 2 included in the initial information stored in the initial information storage unit 32. Then, the equipment information acquisition unit 352 acquires the equipment information output by the information distribution device 2 on the basis of the imaged position information. The equipment information acquisition unit 352 outputs the acquired equipment information to the relative position calculation unit 353.

When it is determined that the equipment information is stored in the memory of the display device 3, the equipment information acquisition unit 352 may further determine whether or not an update command has been received. In such a configuration, when it is determined that the update command has been received, the equipment information acquisition unit 352 acquires the equipment information. When it is determined that the update command has not been received, the equipment information acquisition unit 352 does not perform processing for acquiring the equipment information. The timing at which the update command is input to the equipment information acquisition unit 352 may be arbitrary. For example, when the imaging range of the imaging unit 31 changes by a predetermined rate or more, an update command may be input to the equipment information acquisition unit 352, or an update command based on a user operation may be input to the equipment information acquisition unit 352 via the operation input unit 30.

The relative position calculation unit 353 calculates a relative position of the equipment with respect to the imaging unit 31 on the basis of the imaging absolute position calculated by the imaging position calculation unit 351 and the equipment absolute position indicated by the equipment position information included in the equipment information acquired by the equipment information acquisition unit 352. The relative position calculation unit 353 calculates a relative position of each equipment corresponding to one or more pieces of equipment information among the n pieces of equipment information acquired by the equipment information acquisition unit 352. The relative position of the equipment with respect to the imaging unit 31 includes a relative distance from the imaging unit 31 to the equipment and a relative direction that is a direction of the equipment with respect to the imaging unit 31.

Specifically, the relative position calculation unit 353 calculates a relative distance Lₖ using an arbitrary method for calculating the distance between two points on the basis of the absolute coordinates (X′, Y′, Z′) of the imaging absolute position and the absolute coordinates (Xₖ, Yₖ, Zₖ) of the position of the equipment. In the example illustrated in FIG. 2, the relative position calculation unit 353 calculates a relative distance L₁ from the imaging unit 31 to the end of the pipe on the basis of the absolute coordinates (X′, Y′, Z′) of the imaging absolute position and absolute coordinates (X₁, Y₁, Z₁) of the position of the end of the pipe. In addition, the relative position calculation unit 353 calculates a relative distance L₂ from the imaging unit 31 to the manhole lid on the basis of the absolute coordinates (X′, Y′, Z′) of the imaging absolute position and absolute coordinates (X₂, Y₂, Z₂) of the position of the manhole lid.

More specifically, the relative position calculation unit 353 can calculate the relative distance Lₖ using a geodesic length calculation method disclosed by the Geospatial Information Authority of Japan. Furthermore, the relative position calculation unit 353 can calculate the relative distance Lₖ using spherical trigonometry using the Haversine formula. Note that a geodesic length calculation method is disclosed in https://vldb.gsi.go.jp/sokuchi/surveycalc/surveycalc/algorithm/bl2st/bl2st.htm. Spherical trigonometry is disclosed in http://www.orsj.or.jp/archive2/or60-12/or60_12_701.pdf.

For example, when the absolute coordinates of the imaging absolute position are (36.0000, 139.5000, 0) and the absolute coordinates of the position of the end of the pipe, which is an example of equipment, are (36.000068, 139.50007, 0), the relative position calculation unit 353 can calculate the relative distance L₁ from the imaging unit 31 to the end of the pipe as 9.8400 m using a geodesic length calculation method. Further, the relative position calculation unit 353 can calculate the relative distance L₁ as 9.837 m using spherical trigonometry. In this way, when the relative distance Lₖ of about 10 m is measured, the error between the relative distance Lₖ calculated using the geodesic length calculation method and the relative distance Lk calculated using the spherical trigonometry is only 0.3 cm. Therefore, the relative position calculation unit 353 can calculate the relative distance Lₖ at a higher speed by using the spherical trigonometry in which the calculation method is easier than the geodesic length calculation method.

In addition, the relative position calculation unit 353 calculates a direction of the equipment with respect to the imaging unit 31 on the basis of the mobile station direction included in the mobile station information calculated by the mobile station 33 and the posture of the display device 3 detected by the posture detection unit 34. The relative position calculation unit 353 outputs the calculated direction of the equipment to the image superimposition unit 354.

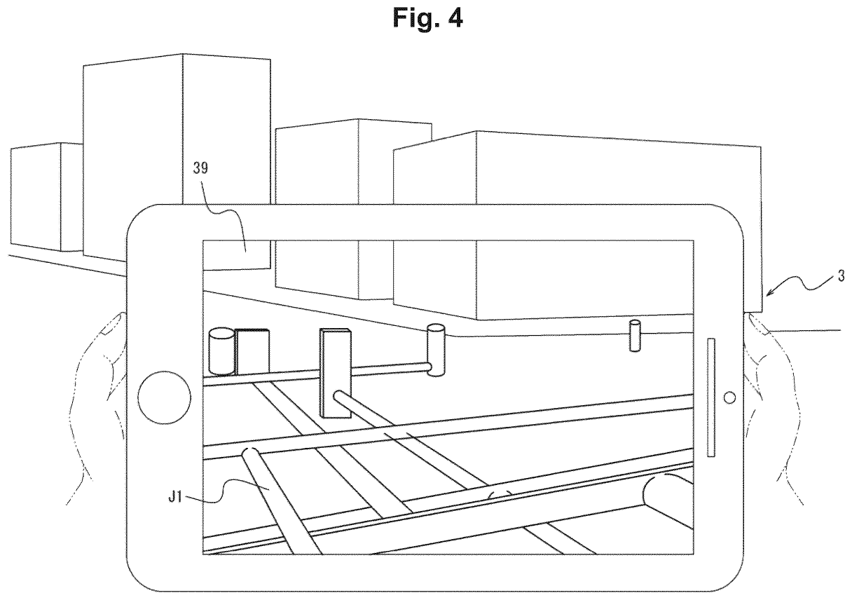

The image superimposition unit 354 generates a superimposed image in which the object J1 corresponding to the equipment is superimposed on the captured image as illustrated in FIG. 4 on the basis of the relative position of the equipment with respect to the imaging unit 31. The object J1 to be superimposed on the captured image by the image superimposition unit 354 is the object J1 corresponding to the equipment acquired by the equipment information acquisition unit 352. The object J1 corresponding to the equipment can be an object included in the equipment information together with the equipment position information. The image superimposition unit 354 superimposes the object J1 on a position in the captured image corresponding to the relative position of the equipment with respect to the imaging unit 31 in the real space. The image superimposition unit 354 outputs the generated superimposed image to the display unit 36.

The display unit 36 includes a display. The display unit 36 displays the superimposed image generated by the image superimposition unit 354. As described above, in the superimposed image, the object J1 corresponding to the equipment is superimposed on the captured image, and thus, the display unit 36 displays the equipment in augmented reality (AR).

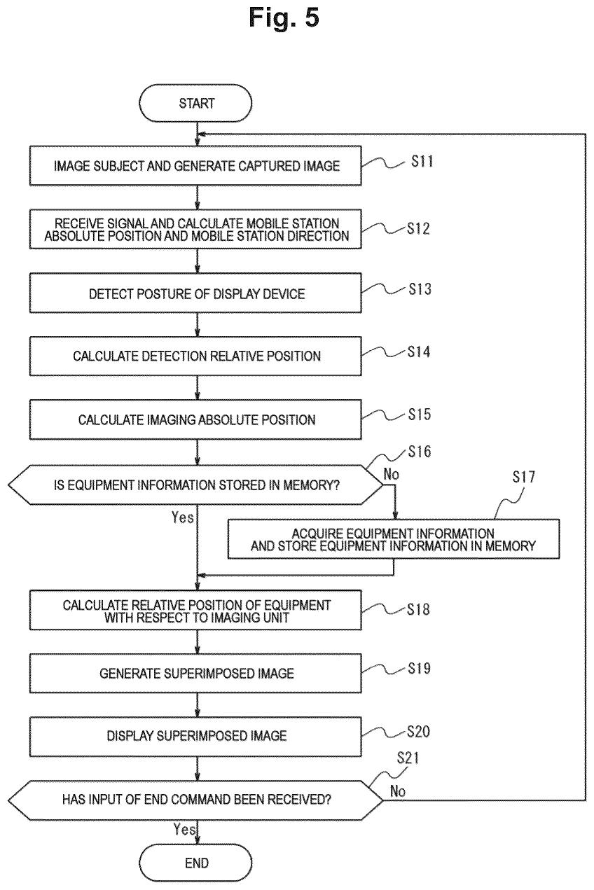

An operation in the display processing of the display device 3 according to the above embodiment will be described with reference to FIG. 5. FIG. 5 is a flowchart illustrating an example of the operation in the display processing of the display device 3 according to the first embodiment. The operation in the display processing of the display device 3 described with reference to FIG. 5 corresponds to the display method according to the first embodiment. In the first embodiment, the display device 3 starts the display processing when the operation input unit 30 receives an input indicating a start command.

In step S11, the imaging unit 31 images a subject and generates a captured image.

In step S12, the mobile station 33 receives a signal from the positioning satellite S, and calculates the mobile station absolute position and the mobile station direction on the basis of the signal.

In step S13, the posture detection unit 34 detects the posture of the display device 3.

In step S14, the imaging position calculation unit 351 calculates the detection relative position Q of the imaging unit 31 with respect to the mobile station 33 on the basis of the posture of the display device 3 detected in step S13 and the known reference relative position P.

In step S15, the imaging position calculation unit 351 calculates the imaging absolute position, on the basis of the mobile station absolute position calculated in step 12 and the detection relative position Q calculated in step S14.

In step S16, the equipment information acquisition unit 352 determines whether or not the equipment information is stored in the memory of the display device 3.

In a case where it is determined in step S16 that the equipment information is not stored in the memory of the display device 3, in step S17, the equipment information acquisition unit 352 acquires the equipment information and stores the equipment information in the memory of the display device 3.

When it is determined in step S16 that the equipment information is stored in the memory of the display device 3 or when the equipment information is acquired in step S17, the relative position calculation unit 353 calculates the relative position of the equipment with respect to the imaging unit 31 in step S18.

In step S19, the image superimposition unit 354 generates a superimposed image on which the object J1 corresponding to the equipment is superimposed.

In step S20, the display unit 36 displays the superimposed image generated in step S19.

In step S21, the control unit 35 determines whether or not an input of an end command has been received. When it is determined that the input of the end command has been received, the display processing is ended. In a case where it is determined that the input of the end command has not been received, the control unit 35 returns to step S11 and repeats the processing.

According to the first embodiment, the display device 3 calculates the relative position of the equipment with respect to the imaging unit 31 on the basis of the imaging absolute position and the equipment absolute position, generates the superimposed image in which the object J1 is superimposed on the captured image on the basis of the relative position, and displays the superimposed image. Therefore, without the equipment manager visiting the site of the road construction, the orderer and the contractor of the road construction can visually ascertain the position of the equipment in order to ensure safe construction. In addition, the orderer and the contractor can easily check equipment buried under the ground or equipment that cannot be directly viewed due to a building on the ground. In particular, in a case where the equipment is a buried object buried under the ground, the orderer and the contractor need to check the buried object by excavation without using the display device 3 of the present embodiment, but can check the position of the buried object without requiring time and effort for excavation by referring to the display device 3. Furthermore, as illustrated in FIG. 4, the orderer and the contractor can perform construction without displaying a mark indicating a position corresponding to the equipment on the ground surface or the like with ink or the like by simultaneously referring to the display device 3 displaying the superimposed image and the construction site in the real space.

In the first embodiment, the equipment information including the object J1 is stored in the equipment information storage unit 20 of the information distribution device 2, and the equipment information acquisition unit 352 acquires the equipment information including the object J1 from the information distribution device 2, but the present invention is not limited thereto. For example, the equipment information may include equipment type information indicating the type of equipment in addition to or instead of the object J1, and the display device 3 may include an object storage unit that stores the equipment type information and the object J1 in association with each other. In such a configuration, the object J1 corresponding to the equipment to be superimposed on the captured image by the image superimposition unit 354 can be the object J1 extracted from the object storage unit on the basis of the equipment type information included in the equipment information acquired by the equipment information acquisition unit 352.

In the first embodiment, the equipment information acquisition unit 352 determines whether or not the equipment information is stored in the memory of the display device 3, but the present invention is not limited thereto. For example, the equipment information acquisition unit 352 may acquire the equipment information on the basis of the imaging absolute position when the imaging absolute position is calculated without determining whether or not the equipment information is stored in the memory.

Hereinafter, a second embodiment of the present disclosure will be described with reference to the drawings.

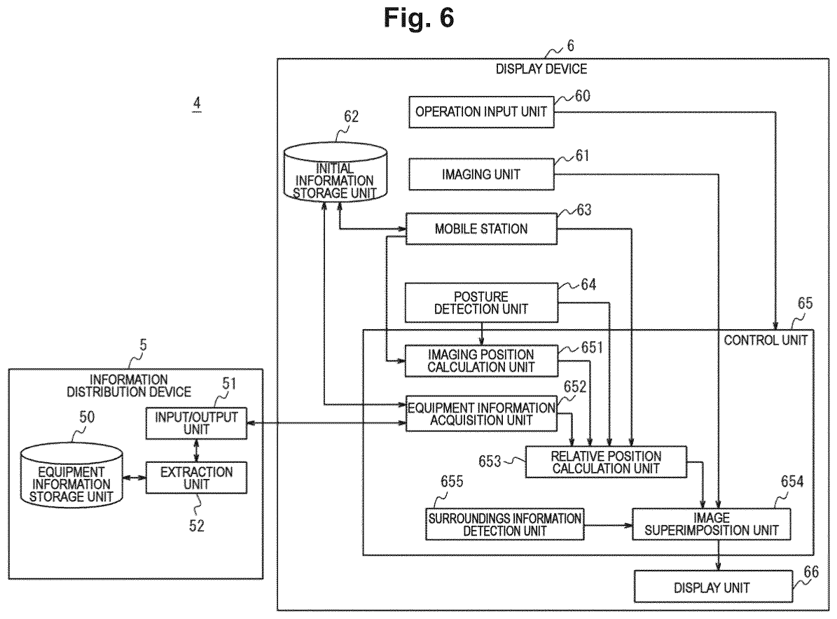

An overall configuration of the second embodiment will be described with reference to FIG. 6. FIG. 6 is a schematic diagram of a display system 4 according to the second embodiment of the present invention.

As illustrated in FIG. 6, the display system 4 according to the second embodiment includes information an information distribution device 5 and a display device 6. The display device 6 is connected to the information distribution device 5 via a communication network, and transmits and receives information to and from each other. In addition, the display device 6 receives a signal from a positioning satellite S of the GNSS.

The information distribution device 5 includes an equipment information storage unit 50, an input/output unit 51, and an extraction unit 52. The equipment information storage unit 50, the input/output unit 51, and the extraction unit 52 are the same as the equipment information storage unit 20, the input/output unit 21, and the extraction unit 22 of the first embodiment, respectively.

Similarly to the display device 3 of the first embodiment, the display device 6 is configured as a computer including a processor, a memory, a display, a camera, an input/output interface, and a sensor.

The display device 6 includes an operation input unit 60, an imaging unit 61, an initial information storage unit 62, a mobile station 63, a posture detection unit 64, a control unit 65, and a display unit 66. The control unit 65 includes an imaging position calculation unit 651, an equipment information acquisition unit 652, a relative position calculation unit 653, an image superimposition unit 654, and a surroundings information detection unit 655. The operation input unit 60, the imaging unit 61, the initial information storage unit 62, the mobile station 63, the posture detection unit 64, the imaging position calculation unit 651, the equipment information acquisition unit 652, the relative position calculation unit 653, and the display unit 66 are the same as the operation input unit 30, the imaging unit 31, the initial information storage unit 32, the mobile station 33, the posture detection unit 34, the imaging position calculation unit 351, the equipment information acquisition unit 352, the relative position calculation unit 353, and the display unit 36 of the first embodiment, respectively.

The surroundings information detection unit 655 includes a sensor that detects a ground surface and an object using, for example, a light detection and ranging (LiDAR) technology. The sensor may be built into the housing of the display device 6 or may be externally attached. The surroundings information detection unit 655 detects surroundings information that is information of a range including at least a part of a range to be imaged by the imaging unit 61. The surroundings information includes ground surface information indicating a relative position of the ground surface with respect to the display device 6, object information indicating a relative position of an object on the ground surface with respect to the display device 6, and the like. Examples of the object include a vehicle, a utility pole, a guardrail, and a building. The ground surface information and the object information may each include texture information.

Similarly to the image superimposition unit 354 of the first embodiment, the image superimposition unit 654 generates a superimposed image in which the object J1 is superimposed on the captured image on the basis of the relative position of the equipment with respect to the imaging unit 61. Further, similarly to the image superimposition unit 354 of the first embodiment, the image superimposition unit 654 superimposes the object J1 on a position in the captured image corresponding to the relative position of the equipment with respect to the imaging unit 61 in the real space.

Further, the image superimposition unit 654 generates a superimposed image on the basis of the surroundings information acquired by the surroundings information detection unit 655.

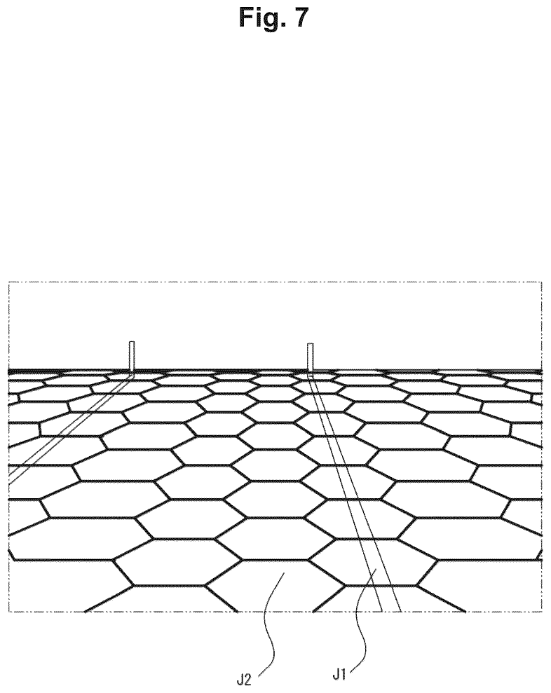

In one example, as illustrated in FIG. 7, the image superimposition unit 654 can superimpose an object J2 indicating the ground surface on a position corresponding to the relative position of the ground surface indicated by the ground surface information in the captured image, and further superimpose an object J1 of the buried object buried under the ground. The object J2 indicating the ground surface is, for example, an object with a mesh-like pattern or color. In this configuration, the information distribution device 5 may store the object J2 indicating the ground surface, and the image superimposition unit 654 may acquire the object J2 indicating the ground surface stored in the information distribution device 5 and superimpose the object J2 on the captured image. Furthermore, the display device 6 may store the object J2 indicating the ground surface, and the image superimposition unit 654 may acquire the object J2 indicating the ground surface stored in the display device 6 and superimpose the object J2 on the captured image.

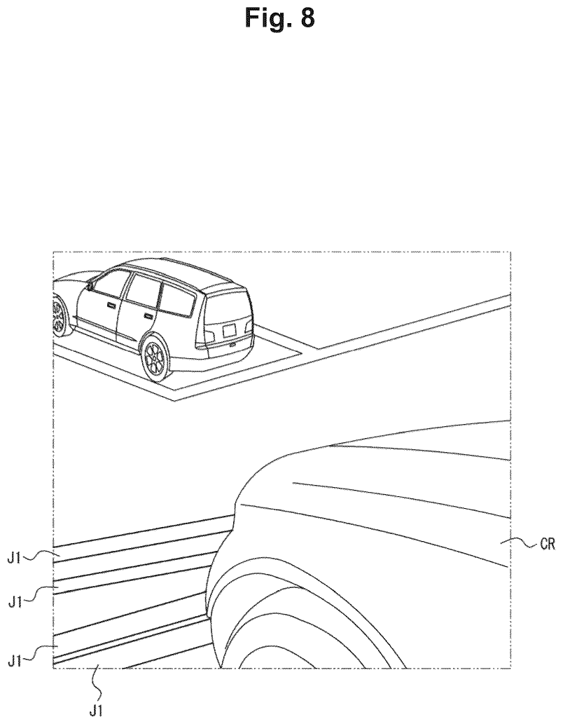

In another example, the image superimposition unit 654 generates a superimposed image in which the object J1 included in the equipment information is superimposed at a position different from the position corresponding to the relative position of the object indicated by the object information in the captured image. In the example of FIG. 8, the surroundings information detection unit 655 detects information indicating that a vehicle CR exists in front of the equipment. In this example, the image superimposition unit 654 does not superimpose the object J1 on the position corresponding to the vehicle CR in the captured image, and superimposes the object J1 on a position different from the position corresponding to the vehicle CR. That is, when an object exists on the ground surface, the object J1 of the buried object is not superimposed on the object.

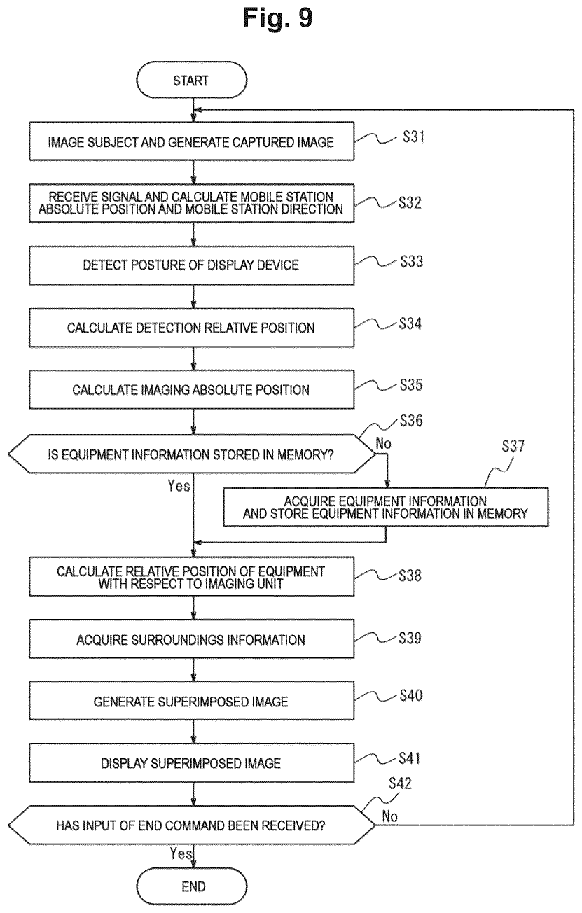

The operation of the display device 6 according to the above embodiment will be described with reference to FIG. 9. FIG. 9 is a flowchart illustrating an example of the operation of the display device 6 according to the embodiment of the present disclosure. The operation of the display device 6 described with reference to FIG. 9 corresponds to the display method according to the present embodiment. In the second embodiment, the display device 6 starts processing when the operation input unit 60 receives an input indicating a start command.

In the second embodiment, the display device 6 performs the processes from step S31 to step S38 which are the same as the processes from step S11 to step S18 of the first embodiment.

In step S39, the surroundings information detection unit 655 detects surroundings information.

In step S40, the image superimposition unit 654 generates a superimposed image in which the object J1 is superimposed on the captured image. At this time, the image superimposition unit 654 generates a superimposed image on the basis of the surroundings information detected by the surroundings information detection unit 655.

In step S41, the display unit 66 displays the superimposed image generated in step S40.

In step S42, the operation input unit 60 determines whether or not an input of an end command has been received. When it is determined that the input of the end command has been received, the display device 6 ends the display processing. When it is determined that the input of the end command has not been received, the display device 6 returns to step S31 and repeats the processing.

According to the second embodiment, the display device 6 detects surroundings information and generates a superimposed image on the basis of the surroundings information. Therefore, the orderer and the contractor can check a place where the equipment is disposed while considering the surrounding environment in the real space, and can more reliably ascertain the position of the equipment. For example, the display device 6 superimposes the object J2 with a mesh-like pattern or color at a position corresponding to the ground surface on the captured image, and further superimposes the object J1 of the buried object buried under the ground. Therefore, the orderer and the contractor can more reliably ascertain the position of the buried object without misunderstanding the positional relationship between the ground surface and the buried object. Therefore, the orderer and the contractor can appropriately ensure safety in construction.

Furthermore, in the display device 6, the object J1 is superimposed at a position different from the position corresponding to the relative position of the object such as the vehicle (the object J1 is not superimposed on the object on the ground surface). Therefore, it is possible to suppress the buried object from being seen to float and to achieve reality. Thereby, the orderer and the contractor can appropriately ascertain the positional relationship between the object and the equipment disposed in the real space. Therefore, the orderer and the contractor can appropriately ensure safety in construction.

A computer can be suitably used to function as each unit of the display device 3 or the display device 6 described above. Such a computer can be implemented by storing a program describing processing contents for realizing the functions of each unit of the display device 3 or the display device 6 in a memory of the computer, and reading and executing the program by a central processing unit (CPU) of the computer. That is, the program can cause a computer to function as the display device 3 or the display device 6 described above.

Furthermore, the program may be recorded in a computer-readable medium. By using a computer-readable medium, the program can be installed in a computer. Here, the computer-readable medium in which the program is recorded may be a non-transitory recording medium. The non-transitory recording medium is not particularly limited, but may be, for example, a recording medium such as a CD-ROM or a DVD-ROM. Moreover, the program can also be provided via a network.

The present disclosure is not limited to the configuration specified in each of the above-described embodiments, and various modifications can be made without departing from the gist of the invention described in the claims. For example, functions and the like included in the respective components and the like can be rearranged so as not to be logically inconsistent, and a plurality of components and the like can be combined or divided into one.

### REFERENCE SIGNS LIST

1, 4 Display system
2, 5 Information distribution device
3, 6 Display device
20, 50 Equipment information storage unit
21, 51 Input/output unit
22, 52 Extraction unit
30, 60 Operation input unit
31, 61 Imaging unit
32, 62 Initial information storage unit
33, 63 Mobile station
34, 64 Posture detection unit
35, 65 Imaging position calculation unit
36, 66 Equipment information acquisition unit
37, 67 Relative position calculation unit
38, 68 Image superimposition unit
39, 69 Display unit
70 Surroundings information detection unit

1. A display device comprising:
an imager configured to image a subject and generate a captured image;
imaging position calculation circuitry configured to calculate an imaging absolute position that is an absolute position of the imager;
equipment information acquisition circuitry configured to acquire an equipment absolute position that is an absolute position of equipment on the basis of the imaging absolute position;
relative position calculation circuitry configured to calculate a relative position of the equipment with respect to the imager on the basis of the imaging absolute position and the equipment absolute position;
image superimposition circuitry configured to generate a superimposed image in which an object corresponding to the equipment is superimposed on the captured image on the basis of the relative position; and
a display to display the superimposed image.

2. The display device according to claim 1, further comprising:
a mobile station configured to receive a signal from a positioning satellite,
wherein:
the mobile station calculates a mobile station absolute position that is an absolute position of the mobile station on the basis of the signal, and
the imaging position calculation circuitry calculates the imaging absolute position, on the basis of the mobile station absolute position and a relative position of the imager with respect to the mobile station.

3. The display device according to claim 2, further comprising:
a posture detection circuitry configured to detect a posture of the display device,
wherein the imaging position calculation circuitry calculates the relative position of the imager with respect to the mobile station on the basis of the posture.

4. The display device according to claim 1, wherein:
the image superimposition circuitry superimposes the object on a position in the captured image corresponding to the relative position of the equipment with respect to the imager in a real space.

5. The display device according to claim 1, further comprising:
a surroundings information detection circuitry configured to acquire surroundings information that is information regarding a range including at least a part of a range to be imaged by the imager,
wherein the image superimposition circuitry superimposes the object on the basis of the surroundings information.

6. The display device according to claim 5, wherein:
the image superimposition circuitry superimposes the object on a position different from a position corresponding to a relative position of an object indicated by the surroundings information in the captured image.

7. A display method, comprising:
imaging a subject using an imager and generating a captured image;
calculating an imaging absolute position that is an absolute position of the imager;
of acquiring an equipment absolute position that is an absolute position of equipment on the basis of the imaging absolute position;
of calculating a relative position of the equipment with respect to the imager on the basis of the imaging absolute position and the equipment absolute position;
of generating a superimposed image in which an object corresponding to the equipment is superimposed on the captured image on the basis of the relative position; and
of displaying the superimposed image.

8. A non-transitory computer readable medium storing a program for causing a computer to function as the display device according to claim 1.
